(19) United States
(12) Patent Application Publication
(10) Pub. No.: US 2026/0236271 A1
(43) Pub. Date: Aug. 13, 2026

(54) METHODS AND SYSTEMS FOR CONFIGURATION MANAGEMENT

(71) Applicant: FIDELITY INFORMATION SERVICES, LLC, Jacksonville, FL (US)

(72) Inventors: Rajeshwaran James THANGARAJ, Bangalore (IN); Mahidhar Reddy YETURU, Bangalore (IN)

(73) Assignee: FIDELITY INFORMATION SERVICES, LLC, Jacksonville, FL (US)

(21) Appl. No.: 19/533,503

(22) Filed: Feb. 9, 2026

Related U.S. Application Data
(60) Provisional application No. 63/755,733, filed on Feb. 7, 2025.

(51) Int. Cl. G06F 9/445

(52) U.S. Cl. CPC G06F 9/44505

(57) ABSTRACT

Embodiments of the present disclosure relate to methods and systems for configuration management in the development and deployment of computer application products. A configuration copy tool (CCT) facilitates accurate, automated, and repeatable movement of definition-level configuration data across multiple environments, including development, testing, integration, and production. In several embodiments, a user searches for and selects a CCT instance for a corresponding tenant, selects a configuration component from a source system, retrieves or downloads details of a previous extraction, and extracts configuration data from a previously extracted time to a current execution time. The system may perform full extracts or delta extracts and may selectively include only approved, active, or passive configuration items while excluding cancelled or in-progress items. Extracted data may be formatted as SQL scripts or other deployment artifacts suitable for promotion through a continuous integration and continuous delivery pipeline (CI/CD) to downstream systems for validation and production deployment. The disclosed system may operate across heterogeneous system groups, support multiple databases, and be deployed in cloud-based container environments. These methods and systems improve accuracy, speed, and reliability of configuration migration, reduce manual intervention, and ensure consistent configuration states across complex software environments.

### FIELD

The present disclosure relates generally to data processing and improvements in application deployment.

### BACKGROUND

Configuration management involves handling the settings and configurations of software applications, development environments, or systems that a program interacts with. This may include managing variables, properties, and environmental settings that control how a program behaves or interfaces with other services, databases, or systems. Managing configuration data across various environments, e.g., development, staging, and production, helps to ensure consistency, scalability, and security. However, existing methods of managing configuration data across multiple environments is complex and prone to errors. Ensuring consistency and accuracy of configuration data is challenging with existing methods.

Modern software applications rely extensively on configuration data to define operational behavior, business rules, product settings, pricing logic, user interface templates, enterprise customer definitions, organizational structures, and other non-operational parameters. As organizations increasingly adopt multi-environment architectures, such as development, testing, quality assurance, integration, and production, the ability to maintain consistent configuration data across these environments has become increasingly difficult.

Conventional approaches to configuration management remain dependent on manual processes. In typical legacy systems, configuration definitions must be recreated, re-entered, or manually synchronized across environments. These traditional methods are time-consuming, labor-intensive, and prone to human error, leading to inconsistencies in configuration states across environments. Such inconsistencies can result in incorrect behavior, test failures, and delays in deployment cycles.

Furthermore, existing systems generally lack the ability to selectively extract only relevant configuration data. For example, there are often limited mechanisms to extract only items in approved, active, or passive states while excluding cancelled or in-progress configurations. Similarly, prior systems do not provide efficient mechanisms for extracting only the configuration changes, also referred to as delta configuration data, made since the last extraction. As a result, organizations are forced to perform entire environment migrations or rely on error-prone comparison processes.

Another challenge with conventional systems is the management of configuration data across heterogeneous technology stacks. Many enterprises operate multiple database platforms, including Oracle and PostgreSQL, requiring configuration management tooling that is compatible with each system. Traditional approaches are inflexible and often hard-coded to a single platform or environment.

With the increasing adoption of cloud technologies and continuous integration/continuous deployment (CI/CD) practices, organizations now benefit from automated and repeatable processes for managing configuration changes. Therefore, there is an increasing need for modern deployment pipelines to comprise configuration extracts that can be validated in downstream environments (such as SIT, UAT, and QA) and then promoted to production in a predictable manner.

### SUMMARY

Embodiments of the present disclosure provide a system and method for improving the accuracy, speed, and reducing potential human error of configuration management in the creation of computer application products.

The inventive systems and methods may comprise multiple embodiments. In some embodiments, a method for configuration management for development of a product is disclosed. According to some embodiments, the method for configuration management may include selecting a CCT for a respective tenant; selecting a configuration component from a source; determining configuration data associated with the selected configuration component from a previously extracted time to a current extracted time; extracting configured data corresponding to the configuration component based on the selected CCT; and providing the extracted configured data for movement to one or more downstream systems to validate the changes and to promote the configuration to production.

In some embodiments, a computer-readable medium that stores a set of instructions that is executable by at least one processor of a computing device to cause the computing device to perform operations for configuration management for development of a product. The computer-readable medium may further perform operations comprising: selecting a configuration component from a source; determining configuration data associated with the selected configuration component from a previously extracted time to a current extracted time; extracting configured data corresponding to the configuration component based on the selected CCT; and providing the extracted configured data for movement to one or more downstream systems to validate the changes and to promote the configuration to production.

In some embodiments, a system for managing configurations in development of a product is disclosed. According to some embodiments, the system comprises a copy configuration tool (CCT), a services database comprising a table of the plurality of different development components and the corresponding configuration data; and a core database comprising the corresponding configuration data for each of the plurality of different development components. According to some embodiments, the CCT is configured facilitate extraction of selected configured data for each of a plurality of different development components and to extract a configuration based on a selected tenant.

Embodiments including system, methods, and computer-readable media implementing the above embodiments are also disclosed herein.

The foregoing general description and the following detailed description are example and explanatory only and are not restrictive of the claims. Other advantages of the embodiments of the present disclosure will become apparent from the following description taken in conjunction with the accompanying drawings wherein are set forth, by way of illustration and example, certain embodiments of the present invention.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in and constitute a part of this specification, illustrate several embodiments consistent with the disclosure and, together with the description, serve to explain the principles of the disclosure. The above and other aspects of the present disclosure will become more apparent from the description of exemplary embodiments, taken in conjunction with the accompanying drawings. In the drawings:

FIG. 1 is an illustration of a configuration management system, consistent with embodiments of the present disclosure.

FIG. 2 is an illustration of a full extract configuration management system, consistent with embodiments of the present disclosure.

FIG. 3 is a flow diagram of a method of operating a full extract configuration management system, consistent with embodiments of the present disclosure.

FIG. 4 is an illustration of a partial extract configuration management system, consistent with embodiments of the present disclosure.

FIG. 5 is a flow diagram of a method of operating a partial extract configuration management system, consistent with embodiments of the present disclosure.

FIG. 6 is a block diagram illustrating an exemplary deployment module for the configuration management system.

FIG. 7 illustrates a diagram of a computing device, consistent with embodiments of the present disclosure.

### DETAILED DESCRIPTION

Reference will now be made in detail to exemplary embodiments, some examples of which are shown in the accompanying drawings.

It is understood that while certain embodiments are discussed to facilitate understanding of various principles and aspects of this disclosure, the embodiments are not described in isolation and the descriptions are not necessarily mutually exclusive. Thus, it is contemplated and understood that described features of principles of any embodiment may be incorporated into other embodiments.

Exemplary disclosed embodiments include apparatus, systems, and methods for streamlining the configuration management process, thereby reducing operational risks, such as user error, and improving time-to-market for new products.

Conventional or traditional systems may require configuration management across multiple environments. However, conventional systems are complex and prone to errors. Ensuring consistency and accuracy of configuration data is challenging. Traditional methods of moving configuration data are time-consuming and labor-intensive: conventional manual processes increase the risk of errors and inconsistencies.

Conventional or traditional systems cannot selectively extract data from the configuration management systems. There is a need to extract only relevant configuration data (e.g., Active, Passive, Approved items) without including cancelled or in-progress items. Conventional systems do not address that organizations use various database systems (e.g., Oracle, Postgres). There is a need for a flexible configuration management system that supports multiple databases. There is a need for a configuration management system that can be deployed in the cloud due to increasing adoption of cloud infrastructure.

Conventional systems often rely on manual configuration management, which requires significant human resources. There is a need to automate these processes to create cost savings and increased efficiency. There is a need for a configuration management system that enhances speed and agility in configuration management to keep up with fast-paced business environments, which require quick movement and testing of configurations.

Therefore, accurate, fast, and reliable configuration management has become critical to meet the need of more complex computer application products.

Methods and systems of configuration management that can addressing the problems of conventional systems and unmet market needs are thus desired. According to some embodiments of the present disclosure, a method and system of configuration management is disclosed which can provide significant value to organizations managing complex configuration data across multiple environments. According to some embodiments of the present disclosure, the method and system of configuration management may enable the movement of the definition data changes (e.g., not operational) from one development environment to other development environments (e.g., the setup in which software developers write, test, and debug their code. A development environment may include tools, frameworks, libraries, and configurations that make the development process efficient and organized, e.g., development, quality assurance, master, production.)

According to some embodiments of the present disclosure, the method and system of configuration management may provide extraction of delta configuration data (e.g., selected functional block may be extracted separately from the full configuration data) and full configuration data (e.g., previous time to current time of all the definition configuration) from source based on the business need. According to some embodiments of the present disclosure, the method and system of configuration management may push the configuration data downstream system to validate the changes and to promote the changes to production.

According to some embodiments of the present disclosure, the method and system of configuration management may facilitate the movement of configuration data across multiple business organization components. According to some embodiments of the present disclosure, the method and system of configuration management may provide an integrated solution for managing configuration data across various environments, e.g., User Acceptance Testing (UAT), System Integration Testing (SIT). According to some embodiments of the present disclosure, the method and system of configuration management may ensure consistency and accuracy of configuration data.

According to some embodiments of the present disclosure, the method and system of configuration management may integrate with the Continuous Integration and Continuous Delivery (CI/CD) Pipeline. For example, once SQL scripts are extracted from the source configuration, they are promoted through the CI/CD pipeline. For example, a database loader may be used to load the generated Structured Query Language (SQL) scripts into multiple target environment databases, e.g., quality assurance (QA), UAT, SIT, production. According to some embodiments of the present disclosure, the method and system of configuration management may allow for verification and acceptance testing in one environment, with the same configuration script then moving to other environments.

According to some embodiments of the present disclosure, the method and system of configuration management may support multiple databases (e.g., Oracle, Postgres), ensuring compatibility and flexibility. According to some embodiments of the present disclosure, the method and system of configuration management may be deployed in the cloud, making it adaptable to modern IT environments.

According to some embodiments of the present disclosure, the method and system of configuration management may automate the generation and promotion of SQL scripts, reducing the need for manual intervention. According to some embodiments of the present disclosure, the method and system of configuration management may reduce manpower requirements across multiple environments, leading to cost savings and increased efficiency.

According to some embodiments of the present disclosure, the method and system of configuration management may enhance speed and agility in configuration management, allowing for faster deployment and testing cycles. According to some embodiments of the present disclosure, the method and system of configuration management may speed up the configuration movement process, meeting the needs of fast-paced business environments.

By addressing these core problems and unmet market needs, the method and system of configuration management may provide significant value to organizations managing complex configuration data across multiple environments.

As used herein, unless specifically stated otherwise, the term “or” encompasses all possible combinations, except where infeasible. For example, if it is stated that a component includes A or B, then, unless specifically stated otherwise or infeasible, the component may include A, or B, or A and B. As a second example, if it is stated that a component includes A, B, or C, then, unless specifically stated otherwise or infeasible, the component may include A, or B, or C, or A and B, or A and C, or B and C, or A and B and C. Expressions such as “at least one of” do not necessarily modify an entirety of a following list and do not necessarily modify each member of the list, such that “at least one of A, B, and C” should be understood as including only one of A, only one of B, only one of C, or any combination of A, B, and C. The phrase “one of A and B” or “any one of A and B” shall be interpreted in the broadest sense to include one of A, or one of B.

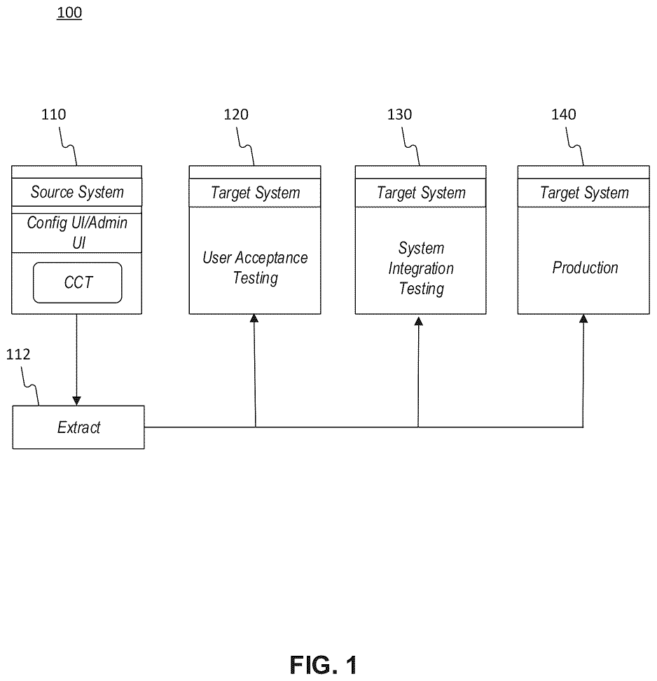

Reference is now made to FIG. 1, which illustrates the configuration management system 100, consistent with embodiments of the present disclosure. According to some embodiments, the configuration management system 100 may provide an integrated solution for managing the configuration data across various environments. According to some embodiments, the configuration management system 100 provides a way to move the definition data changes (not operational) from one environment to another environments. As shown in exemplary diagram of FIG. 1, configuration data may be extracted from source, whether delta or full, based on the business need and pushed to downstream system to validate the changes and to promote to production.

According to some embodiments, configuration management system 100 may comprise a source system 110, a first target system 120, a second target system 130, and a third target system 130. It should be appreciated that there may be any number of target systems. Source system 110 may be accessed through a configuration user interface (UI) or an administrator UI. The configuration UI and the administrator UI may activate the Copy Configuration Tool (CCT) to extract the extracted configuration. The extracted configuration may be a full extract or a delta extract.

The CCT may send the extract to any one or more of the target systems 120, 130, 140.

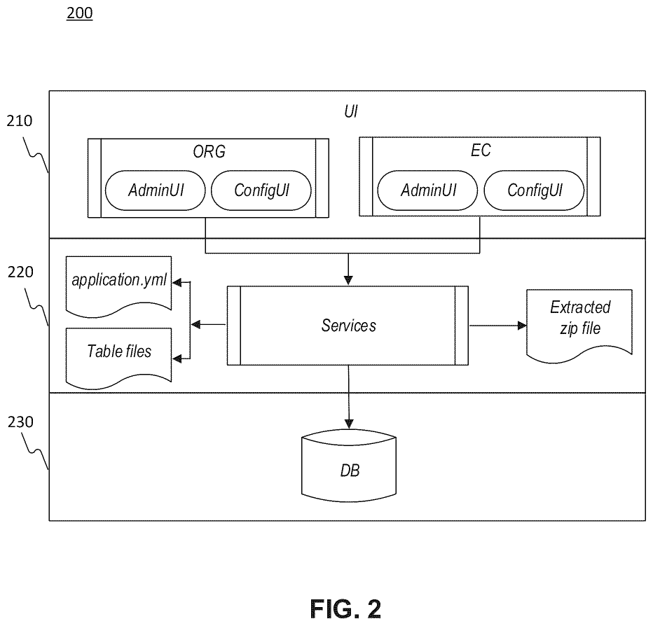

Reference is now made to FIG. 2, which illustrates the full extract configuration management system 200, consistent with embodiments of the present disclosure. According to some embodiments, the full extract configuration management system 200 may implement the configuration management system 100, as described above with respect to FIG. 1. According to some embodiments, full extract configuration management system 200 may comprise CCT 210, services 220, and database 230. CCT 210 may facilitate extraction of configured data for different components, e.g., organization (ORG) or customer (EC) components. The extract may consider all the data to be extracted from previous extracted timestamp to current extraction timestamp which maintained at CCT level. A list of Business definition tables may be maintained at a .yaml file (or file in another format) to extract only from the data and to avoid extracting processing level data, for example, adding new address type in the EC components; adding new branch at ORG component level.

One or more users may interact with CCT 210 through a UI that comprises one or more computing devices by using a display, keyboard, mouse, microphone, touchpad, camera, sensor (e.g., touch sensor) and other input/output devices, via typed text, touch, voice, movement, computer vision, gestures, and/or other forms of input/output. An input/output device may be removable (e.g., a connectable mouse or keyboard) or may be an integral part of the computing device (e.g., a touchscreen, a built-in microphone). CCT 210 may support interaction between an embodiment and one or more users. CCT 210 may include one or more of a command line interface, a graphical user interface (GUI), natural user interface (NUI), voice command interface, and/or other user interface (UI) presentations, which may be presented as distinct options or may be integrated. A user may enter commands and information through a user interface or other input devices such as a tablet, electronic digitizer, a microphone, keyboard, and/or pointing device, commonly referred to as mouse, trackball or touch pad.

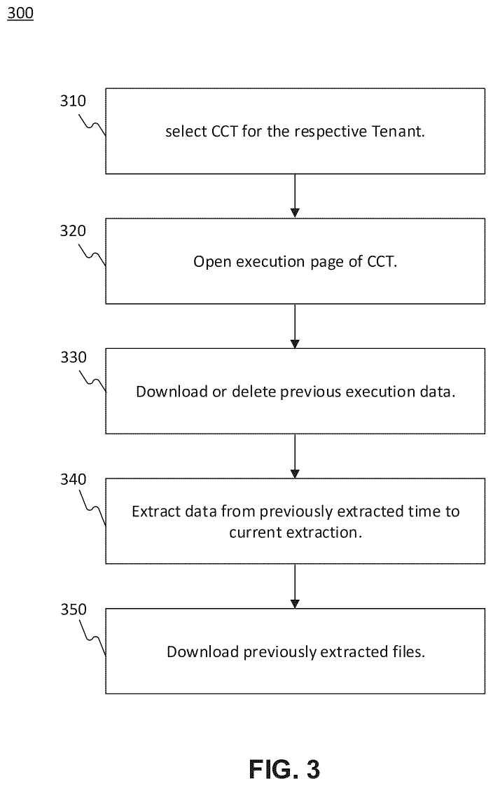

Reference is now made to FIG. 3, which illustrates a method for operating the full extract configuration management system 300, consistent with embodiments of the present disclosure. According to some embodiments, one or more steps of method 300 may be performed by full extract configuration management system 200, as described above with respect to FIG. 2. In other embodiments, method 300 may be performed by a device or system not pictured in FIG. 2.

According to some embodiments, method for operating the full extract configuration management system 300 may include step 310, in which a search and filter may be performed. The search and filter may filter results to a preselected CCT and select the CCT for a corresponding tenant.

According to some embodiments, method for operating the full extract configuration management system 300 may include step 320, in which a component from a Source UI menu may be selected. This selection may prompt the execution page for the CCT to open.

According to some embodiments, method for operating the full extract configuration management system 300 may include step 330, in which a previous delta extraction may be downloaded. Details of the last extraction may be deleted. The full extract configuration management system 200 may be executed again from the same time.

According to some embodiments, method for operating the full extract configuration management system 300 may include step 340, in which the data from a previously extracted time to a current execution time may be extracted.

According to some embodiments, method for operating the full extract configuration management system 300 may include step 350, in which the history screen may display the history of all the successful extracts till date. Previously extracted files may be downloaded.

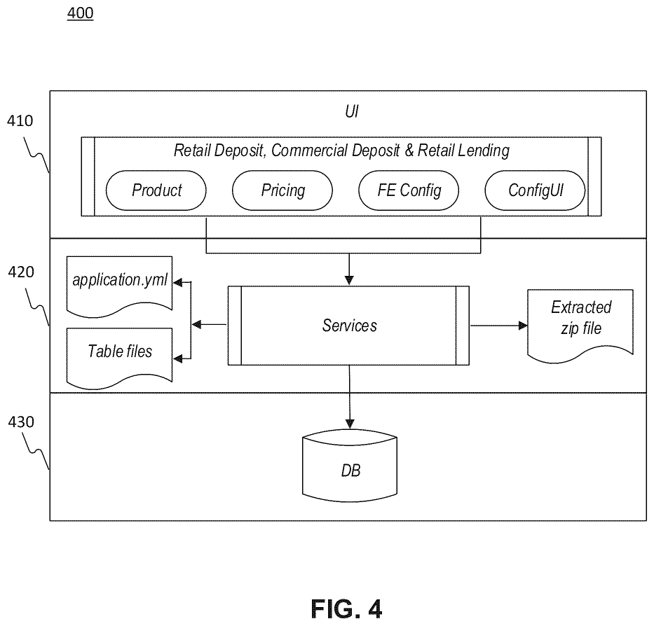

Reference is now made to FIG. 4, with illustrates the partial extract configuration management system 400, consistent with embodiments of the present disclosure. According to some embodiments, the full extract configuration management system 200 may implement the configuration management system 100, as described above with respect to FIG. 1. According to some embodiments, partial extract configuration management system 400 may provide feasibility to extract the configured data partially. Partial extract configuration management system 400 may apply to different business units, software applications, etc., e.g., Retail Deposit, Commercial Deposit. and Retail Lending. Partial extract configuration management system 400 may enable a user to select one or more applications to extract configurations when in different developmental states, e.g., Active, Passive, Approved. This may prevent cancelled and in progress configuration items from being extracted. Partial extract configuration management system 400 may extract configuration details from the previously extracted timestamp to current timestamp.

According to some embodiments, partial extract configuration management system 400 may comprise CCT 410, services 420, and database 430. CCT 410 may facilitate extraction of configured data for different components.

One or more users may interact with CCT 410 through a UI that comprises one or more computing devices by using a display, keyboard, mouse, microphone, touchpad, camera, sensor (e.g., touch sensor) and other input/output devices, via typed text, touch, voice, movement, computer vision, gestures, and/or other forms of input/output. An input/output device may be removable (e.g., a connectable mouse or keyboard) or may be an integral part of the computing device (e.g., a touchscreen, a built-in microphone). CCT 410 UI may support interaction between an embodiment and one or more users. CCT 410 UI may include one or more of a command line interface, a graphical user interface (GUI), natural user interface (NUI), voice command interface, and/or other user interface (UI) presentations, which may be presented as distinct options or may be integrated. A user may enter commands and information through a user interface or other input devices such as a tablet, electronic digitizer, a microphone, keyboard, and/or pointing device, commonly referred to as mouse, trackball or touch pad.

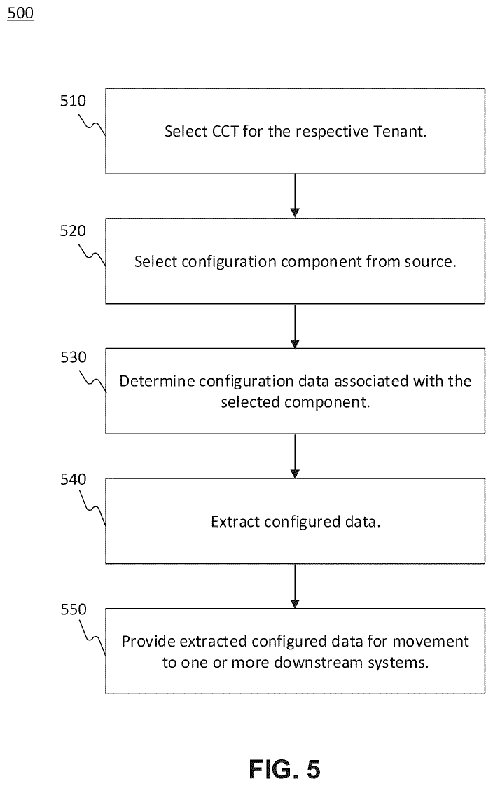

Reference is now made to FIG. 5, with illustrates a method of operating the partial extract configuration management system 500, consistent with embodiments of the present disclosure. According to some embodiments, one or more steps of method 500 may be performed by full extract configuration management system 400, as described above with respect to FIG. 4. In other embodiments, method 500 may be performed by a device or system not pictured in FIG. 4.

According to some embodiments, method 500 may include step 510, in which a selection of a CCT for a respective tenant may be performed. For example, as described above with respect to FIG. 5, selecting a CCT for a respective tenant may be performed by searching and filtering within a user interface to locate the tenant-specific CCT entry and selecting that entry to open the execution page associated with the respective tenant.

According to some embodiments, method 500 may include step 520, in which a determination of configuration data of the selected component may be performed. For example, as described above with respect to FIG. 5, determining configuration data of the selected component may be performed by loading the component-specific configuration tables, retrieving the previously extracted time for that component, and identifying the configuration data associated with the selected component that is to be extracted between the previously extracted time and the current execution time.

According to some embodiments, method 500 may include step 530, in which the configuration data is extracted. For example, configuration data may be extracted through automated, tool-specific methods, including API calls, database queries (SQL), parsing text files with regular expressions (regex), and/or using GUI-based export tools.

According to some embodiments, method 500 may include 540, in which extracted configured data for movement to one or more downstream systems may be performed. Extracted configured data may be moved to one or more downstream systems using, for example, ETL (Extract, Transform, Load) processes, APIs, or message queues. Movement of data may comprise movement from a source (e.g., databases, applications) to a target (e.g., warehouses, BI tools etc.) via the CI/CD pipeline. In some embodiments, the one or more downstream systems may be configured to validate the extracted configured data and promote the validated extracted configured data to subsequent environments.

According to some embodiments, method 500 may include step 550, in which the required files may be extracted and downloaded. For example, as described above with respect to FIG. 5, extracting and downloading the required files may be performed by executing the extraction operation to generate SQL scripts corresponding to the configuration data for the selected component, packaging the generated scripts into a downloadable archive, and presenting a download icon on the execution page that enables a user to retrieve the extracted files for validation and promotion to downstream environments.

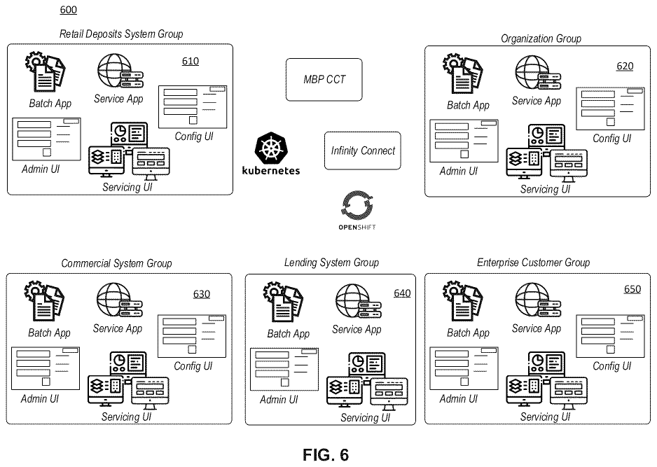

Reference is now made to FIG. 6, which illustrates an exemplary deployment module 600 for the configuration management system. According to some embodiments, deployment module 600 may utilize the configuration management system 100, as described above with respect to FIG. 1, the full configuration management system 200, as described above with respect to FIG. 2, and/or the partial configuration management system 400, as described above with respect to FIG. 4. For example, exemplary deployment module 600 may be an OpenShift cloud deployment module.

In the illustrated embodiment, the deployment module 600 may include a plurality of system groups, each corresponding to a different business domain or application area. These system groups may include, for example, a Retail Deposits System Group 610, an Organization Group 620, a Commercial System Group 630, a Lending System Group 640, and an Enterprise Customer Group 650. Each system group may represent a logical or functional domain within a larger banking or enterprise application platform. Each system group may include one or more computers, applications, components, or the like. Each system group may include one or more components, such as: a Batch App, which may perform scheduled or backend processing; a Service App, which may expose services, APIs, or business logic for the group; an Admin UI, which may allow administrative configuration and management of the group; a Config UI, which may expose configuration-related data and metadata; and a Servicing UI, which may provide servicing-level functionality for users interacting with that group.

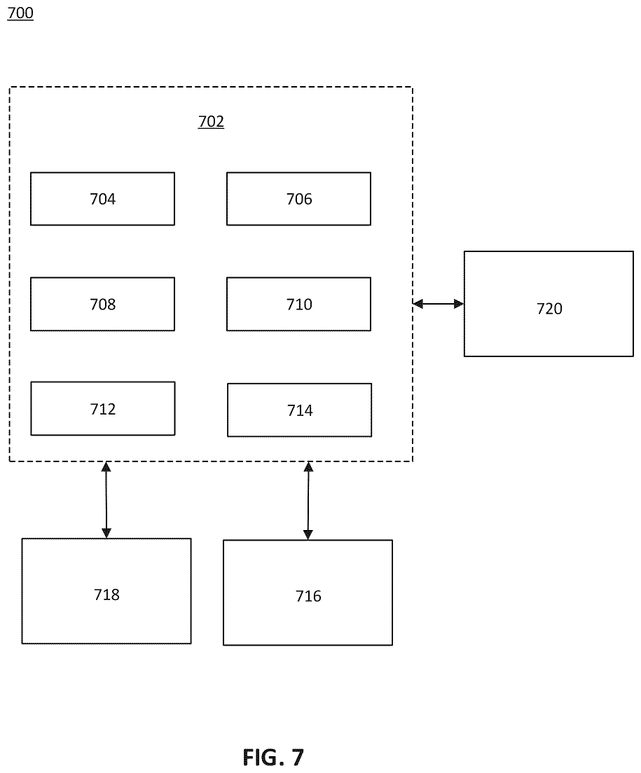

Reference is now made to FIG. 7, which illustrates an exemplary operating environment for implementing various aspects of this disclosure. As illustrated in FIG. 7, an exemplary operating environment 700 may include a computing device 702 (e.g., a general-purpose computing device) in the form of a computer. Components of the computing device 702 may include, but are not limited to, various hardware components, such as one or more processors 706, data storage 708, a system memory 704, other hardware 710, and a system bus (not shown) that couples (e.g., communicably couples, physically couples, and/or electrically couples) various system components such that the components may transmit data to and from one another.

With further reference to FIG. 7, an operating environment 700 for an exemplary embodiment includes at least one computing device 702. The computing device 702 may be a uniprocessor or multiprocessor computing device. An operating environment 700 may include one or more computing devices (e.g., multiple computing devices 702) in a given computer system, which may be clustered, part of a local area network (LAN), part of a wide area network (WAN), client-server networked, peer-to-peer networked within a cloud, or otherwise communicably linked. A computer system may include an individual machine or a group of cooperating machines. A given computing device 702 may be configured for end-users, e.g., with applications, for administrators, as a server, as a distributed processing node, as a special-purpose processing device, or otherwise configured to train machine learning models and/or use machine learning models.

One or more users may interact with the computer system comprising one or more computing devices 702 by using a display, keyboard, mouse, microphone, touchpad, camera, sensor (e.g., touch sensor) and other input/output devices 718, via typed text, touch, voice, movement, computer vision, gestures, and/or other forms of input/output. An input/output device 718 may be removable (e.g., a connectable mouse or keyboard) or may be an integral part of the computing device 702 (e.g., a touchscreen, a built-in microphone). A user interface 712 may support interaction between an embodiment and one or more users. A user interface 712 may include one or more of a command line interface, a graphical user interface (GUI), natural user interface (NUI), voice command interface, and/or other user interface (UI) presentations, which may be presented as distinct options or may be integrated. A user may enter commands and information through a user interface or other input devices such as a tablet, electronic digitizer, a microphone, keyboard, and/or pointing device, commonly referred to as mouse, trackball or touch pad.

Computing device 702 includes at least one logical processor 706. The at least one logical processor 706 may include circuitry and transistors configured to execute instructions from memory (e.g., memory 704). For example, the at least one logical processor 706 may include one or more central processing units (CPUs), arithmetic logic units (ALUs), Floating Point Units (FPUs), and/or Graphics Processing Units (GPUs). The computing device 702, like other suitable devices, also includes one or more computer-readable storage media, which may include, but are not limited to, memory 704 and data storage 708. In some embodiments, memory 704 and data storage 708 may be part a single memory component. The one or more computer-readable storage media may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium 720 such as a portable (i.e., external) hard drive, compact disc (CD), Digital Versatile Disc (DVD), memory stick, or other removable non-volatile memory medium may become functionally a technological part of the computer system when inserted or otherwise installed with respect to one or more computing devices 702, making its content accessible for interaction with and use by processor(s) 706. The removable configured medium 720 is an example of a computer-readable storage medium. Some other examples of computer-readable storage media include built-in random access memory (RAM), read-only memory (ROM), hard disks, and other memory storage devices which are not readily removable by users (e.g., memory 704). In some embodiments, configured medium 720 may be non-transitory.

The configured medium 720 may be configured with instructions (e.g., binary instructions) that are executable by a processor 706; “executable” is used in a broad sense herein to include machine code, interpretable code, bytecode, compiled code, and/or any other code that is configured to run on a machine, including a physical machine or a virtualized computing instance (e.g., a virtual machine or a container). The configured medium 720 may also be configured with data which is created by, modified by, referenced by, and/or otherwise used for technical effect by execution of the instructions. The instructions and the data may configure the memory or other storage medium in which they reside; such that when that memory or other computer-readable storage medium is a functional part of a given computing device, the instructions and data may also configure that computing device.

Although an embodiment may be described as being implemented as software instructions executed by one or more processors in a computing device (e.g., general-purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include other hardware logic components 710 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In some embodiments, the system includes multiple computing devices 702 connected by network(s) 716. Networking interface equipment can provide access to network(s) 716, using components (which may be part of a network interface 714) such as a packet-switched network interface card, a wireless transceiver, or a telephone network interface, for example, which may be present in a given computer system. However, an embodiment may also communicate technical data and/or technical instructions through direct memory access, removable non-volatile media, or other information storage-retrieval and/or transmission approaches.

The computing device 702 may operate in a networked or cloud-computing environment using logical connections to one or more remote devices (e.g., using network(s) 716), such as a remote computer (e.g., another computing device 702). The remote computer may include one or more of a personal computer, a server, a router, a network PC, or a peer device or other common network node, and may include any or all of the elements described above relative to the computer. The logical connections may include one or more LANs, WANs, and/or the Internet.

Computing device 702 typically may include any of a variety of computer-readable media. Computer-readable media may be any available media that can be accessed by the computer and includes both volatile and nonvolatile media, and removable and non-removable media, but excludes propagated signals. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, electrically erasable programmable read-only memory (EEPROM), flash memory or other memory technology, CD-ROM, DVD or other optical disk storage, magnetic cassettes, magnetic tape, magnetic disk storage or other magnetic storage devices, or any other medium which can be used to store the desired information (e.g., program modules, data for a machine learning model, and/or a machine learning model itself) and which can be accessed by the computer.

The data storage 708 or system memory includes computer storage media in the form of volatile and/or nonvolatile memory such as ROM and RAM. A basic input/output system (BIOS), containing the basic routines that help to transfer information between elements within computer, such as during start-up, may be stored in ROM. RAM may contain data and/or program modules that are immediately accessible to and/or presently being operated on by processing unit. By way of example, and not limitation, data storage holds an operating system, application programs, and other program modules and program data.

Data storage 708 may also include other removable/non-removable, volatile/nonvolatile computer storage media. By way of example only, data storage may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

Computer-readable media may be embodied as a computer program product, such as software (e.g., including program modules) stored on non-transitory computer-readable storage media. Any combination of one or more computer-readable medium(s) may be utilized. The computer-readable medium may be a non-transitory computer-readable storage medium.

It will be apparent to those skilled in the art that various modifications and variations can be made to the environment instantiation platform. While illustrative embodiments have been described herein, the scope of the invention includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. It is intended, therefore, that the specification and examples be considered as exemplary only, with a true scope and spirit of the invention being indicated by the following claims and their full scope of equivalents.

1. A computer-implemented method for extracting configuration data across computing environments using a copy configuration tool (CCT), the computer-implemented method comprising:
selecting a CCT for a respective tenant;
selecting a configuration component from a source;
determining configuration data associated with the selected configuration component from a previously extracted time to a current execution time;
extracting configured data corresponding to the configuration component based on the selected CCT; and
providing the extracted configured data for movement to one or more downstream systems, the one or more downstream systems configured to validate the extracted configured data and promote the validated extracted configured data to subsequent environments.

2. The computer-implemented method of claim 1, wherein the selected component comprises one of a retail deposit, commercial deposit, or retail lending.

3. The computer-implemented method of claim 1, further comprising downloading a file of the extracted configured data.

4. The computer-implemented method of claim 1, further comprising downloading a previously extracted file corresponding to the selected configuration component.

5. The computer-implemented method of claim 1, wherein extracting the configured data comprises extracting delta configuration data based on changes occurring between the previously extracted time and the current execution time.

6. The computer-implemented method of claim 1, wherein extracting the configured data comprises extracting full configuration data comprising configuration data from a previous time to the current execution time.

7. The computer-implemented method of claim 1, wherein selecting the configuration component from the source comprises selecting the configuration component via a source user interface (UI) menu.

8. The computer-implemented method of claim 1, wherein the configuration component comprises one of a plurality of different development components stored in a services database.

9. The computer-implemented method of claim 1, wherein extracting the configured data comprises preventing at least one or more of cancelled or in-progress configuration items from being extracted.

10. The computer-implemented method of claim 1, wherein the CCT is configured to support a plurality of databases.

11. The computer-implemented method of claim 1, wherein providing the extracted configured data comprises automatically generating SQL scripts configured for promotion through a CI/CD pipeline.

12. The computer-implemented method of claim 1, wherein the configuration management is deployable in a cloud environment.

13. The computer-implemented method of claim 1, further comprising displaying a history of successful extracts and enabling download of previously extracted files.

14. The computer-implemented method of claim 1, wherein the selected configuration component comprises definition data and excludes operational data.

15. The computer-implemented method of claim 1, wherein searching and filtering based on the configuration copy tool comprises filtering results to a preselected CCT and selecting the CCT for a corresponding tenant.

16. A system comprising:
at least one processor; and
a non-transitory computer readable storage medium comprising instructions, the instructions configured to cause the at least one processor to perform operations comprising:
selecting the CCT for a respective tenant;
selecting a configuration component from a source;
determining configuration data associated with the selected configuration component from a previously extracted time to a current execution time;
extracting configured data corresponding to the configuration component based on the selected CCT; and
providing the extracted configured data for movement to one or more downstream systems, the one or more downstream systems configured to validate the extracted configured data and promote the validated extracted configured data to subsequent environments.

17. The system of claim 16, wherein the operations further comprise downloading a previously extracted file corresponding to the selected configuration component.

18. The system of claim 16, wherein extracting the configured data comprises extracting delta configuration data based on changes occurring between the previously extracted time and the current execution time.

19. The system of claim 16, wherein extracting the configured data comprises extracting full configuration data comprising configuration data from a previous time to the current execution time.

20. The system of claim 16, wherein selecting the configuration component from the source comprises selecting the configuration component via a source user interface (UI) menu.
